(19) United States
(12) Patent Application Publication
(10) Pub. No.: US 2026/0110418 A1
(43) Pub. Date: Apr. 23, 2026

(54) A STRUCTURE FOR FACILITATING SPECTRALLY SELECTIVE TRANSFORMATION OF LIGHT WAVES

(71) Applicant: IYRIS TECHNOLOGY LTD, Hove, East Sussex (GB)

(72) Inventors: Daniel Thomas James BRYANT, Thuwal (SA); Derya Baran BARAN, Thuwal (SA)

(73) Assignee: IYRIS TECHNOLOGY LTD, Hove, East Sussex (GB)

(21) Appl. No.: 19/120,527

(22) PCT Filed: Oct. 15, 2023
(86) PCT No.: PCT/IB2023/060390

§ 371 Date: Apr. 11, 2025

Related U.S. Application Data
(60) Provisional application No. 63/416,008, filed on Oct. 14, 2022.

(51) Int. Cl. A01G 7/04; F21V 9/04; F21V 9/20

(52) U.S. Cl. CPC F21V 9/20; A01G 7/045; F21V 9/04; G02B 5/223; G02F 1/133509

(57) ABSTRACT

A structure for facilitating spectrally selective transformation of light waves includes a substrate comprising a first substrate portion comprising a first material and a second substrate portion comprising a second material assembled with the first substrate portion. The first material has a first level of reflection for a first region of the light wave, which is greater than first levels of reflection for first regions of the light wave. The second material has a second level of transmission for the first region which is greater than second levels of transmission for the first regions. The second material has a third level of absorption for a second region of the light wave which is greater than third levels of absorption for second regions of the light wave. The second substrate portion absorbs a light wave portion associated with the second region and produces thermal energy based on the absorbing.

### CROSS-REFERENCE TO RELATED APPLICATION

This application claims the benefit of U.S. Provisional Patent Application No. 63/416,008, titled “THERMALLY BENEFICIAL LIGHT-ENHANCING HORTICULTURE GROUND FLOOR COVERS”, filed Oct. 14, 2022, which is incorporated by reference herein in its entirety.

### FIELD OF THE INVENTION

Generally, the present disclosure relates to the field of plant husbandry. More specifically, the present disclosure relates to a structure for facilitating spectrally selective transformation of light waves.

### BACKGROUND OF THE INVENTION

The field of plant husbandry which includes materials for protective coverings used for soil and plants is technologically important to several agricultural-based industries, business organizations, and/or individuals. In particular, the use of materials for protective coverings used for soil and plants is prevalent in horticulture. Horticulture ground floor covers, such as those found in greenhouses, serve multiple purposes. In their most basic function, they provide a barrier between the greenhouse and the soil/ground beneath as well as a more stable flooring for humans and equipment. Commonly these ground floor coverings are made over a woven material, such as polypropylene raffia, to allow moisture and air to permeate through as needed. To benefit the greenhouse in terms of optics, the ground floor coverings are commonly pigmented white or black. In the case of the white pigmented ground floor coverings, these are highly reflective or scattering in the photosynthetically active radiation (or PAR) region to reflect some unabsorbed light back to the plants. Black pigmented ground floor coverings absorb all radiations of the solar spectrum and convert the lights to heat to provide some additional heating to greenhouses.

Existing techniques for covering soils in horticulture are deficient with regard to several aspects. Previously it has been suggested to include selectively selective inorganic pigments within ground coverings to absorb the NIR whilst reflecting the PAR. However, these materials do not include any storage of the NIR energy or any further enhancement of the light spectrum, beyond reflection.

Therefore, there is a need for a structure for facilitating spectrally selective transformation of light waves that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a structure for facilitating spectrally selective transformation of light waves, in accordance with some embodiments. Further, the structure may include a substrate. Further, the substrate may include at least one first substrate portion and at least one second substrate portion. Further, the at least one first substrate portion may include at least one first material. Further, the at least one first material has a first level of reflection for a first region of the light wave and one or more first levels of reflection for one or more first regions of the light wave. Further, the first level of reflection may be greater than one or more first levels of reflection. Further, the at least one second substrate portion may be assembled with the at least one first substrate portion. Further, the at least one second substrate portion may include at least one second material. Further, the at least one second material has a second level of transmission for the first region of the light wave and one or more second levels of transmission for the one or more first regions of the light wave. Further, the second level of transmission may be greater than the one or more second levels of transmission. Further, the at least one second material has a third level of absorption for a second region of the light wave and one or more third levels of absorption for one or more second regions of the light wave. Further, the second level of absorption may be greater than the one or more second levels of absorption. Further, the at least one second substrate portion may be configured for absorbing at least one light wave portion associated with the second region of the light wave based on the at least one second material. Further, the at least one second substrate portion may be configured for producing at least one amount of thermal energy based on the absorbing of the at least one light wave portion.

Further disclosed herein is a method for producing a structure for facilitating spectrally selective transformation of light waves, in accordance with some embodiments. Accordingly, the method may include a step of adding at least one first material in at least one first substrate portion of a substrate. Further, the at least one first material has a first level of reflection for a first region of the light wave and one or more first levels of reflection for one or more first regions of the light wave. Further, the first level of reflection may be greater than one or more first levels of reflection. Further, the method may include a step of adding at least one second material in at least one second substrate portion of the substrate. Further, the at least one second material has a second level of transmission for the first region of the light wave and one or more second levels of transmission for the one or more first regions of the light wave. Further, the second level of transmission may be greater than the one or more second levels of transmission. Further, the at least one second material has a third level of absorption for a second region of the light wave and one or more third levels of absorption for one or more second regions of the light wave. Further, the second level of absorption may be greater than the one or more second levels of absorption. Further, the at least one second substrate portion may be configured for absorbing at least one light wave portion associated with the second region of the light wave based on the at least one second material. Further, the at least one second substrate portion may be configured for producing at least one amount of thermal energy based on the absorbing of the at least one light wave portion. Further, the method may include a step of assembling the at least one first substrate portion and the at least one second substrate portion for forming the structure.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top perspective view of a structure 100 for facilitating spectrally selective transformation of light waves, in accordance with some embodiments.

FIG. 2 is a top perspective view of the structure 100, in accordance with some embodiments.

FIG. 3 is a top perspective view of the structure 100, in accordance with some embodiments.

FIG. 4 is an enlarged partial view of a structure 400 for facilitating spectrally selective transformation of light waves, in accordance with some embodiments.

FIG. 5 is a flowchart of a method 500 for producing a structure for facilitating spectrally selective transformation of light waves, in accordance with some embodiments.

FIG. 6 is a flowchart of a method 600 for producing the structure for facilitating spectrally selective transformation of light waves, in accordance with some embodiments.

FIG. 7 is a flowchart of a method 700 for producing the structure for facilitating spectrally selective transformation of light waves, in accordance with some embodiments.

FIG. 8 is a flowchart of a method 800 for producing spectrally selective horticulture ground covering, in accordance with some embodiments.

FIG. 9 is a flowchart of a method 900 for facilitating enhancing photosynthetically active radiation and heating in a greenhouse, in accordance with some embodiments.

FIG. 10 illustrates a structure 1002 disposed on a horticulture ground enclosed by a greenhouse 1004, in accordance with some embodiments.

FIG. 11 illustrates a graph 1100 showing temperature curves of a spectrally selective groundsheet and a groundsheet disposed in a greenhouse, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and is made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a structure for facilitating spectrally selective transformation of light waves, embodiments of the present disclosure are not limited to use only in this context.

### Overview

The present disclosure describes a structure for facilitating spectrally selective transformation of light waves. Further, the structure may be a thermally beneficial light-enhancing horticulture ground floor cover.

Further, the present disclosure describes thermally beneficial light-enhancing horticulture ground floor covers. The disclosed ground floor covers (or coverings) may be spectrally selective horticulture coverings with integrated energy storage and light-enhancing luminescence, for internal use within a greenhouse. The material of the coverings consists of five distinct components including an industrial polymer, a reflective component, a spectrally selective component, a phase change material, and a luminescent material. Industrial polymer consists of any common polymer used for ground-covering materials, examples include polypropylene and polyethylene. The reflective component consists of highly scattering pigments such as metal oxides (TiO2 or ZnO) and metal carbonates (CaCO3 and MgCO3) or metallic pigments such as aluminum, silver, and tungsten. The spectrally selective component consists of an absorbing pigment that includes high transparency in the visible/PAR region (400-700 nm) and high absorption in the NIR region of the spectrum (700-2500 nm). Suitable materials for the spectrally selective component include doped metal oxide nanoparticles such as doped tungsten oxide, lanthanum hexaboride, and near-infrared (or NIR) absorbing dyes. The spectrally selective component may either be compounded inside the industrial polymer (along with the reflective component) or coated as a layer on top of the industrial polymer and reflective pigment. The phase change material (or PCM) consists of any material that goes through a phase change within the temperature range of −20 degrees Celsius to 100 degrees Celsius. Common materials for the phase change material include paraffin waxes, hydrated salts, and bio-derived materials (e.g. Oleic acid). The luminescent material absorbs light of a wavelength within the range of 200-750 nanometers and re-emits light of a wavelength in the 250-750 nm range. Common materials suitable for luminescent materials include perylene dyes, quantum dots, and rhodamine dyes.

The mechanism of action is that the spectrally selective component may preferentially absorb the NIR portion of the spectrum. This radiative energy may thereby get converted into thermal energy, which can be transferred to the surroundings such as the interior of the greenhouse by conduction or convection and provide a heating effect. Any excess thermal energy may be stored within the PCM. The PAR region may be relatively unaffected by the spectrally selective component and can be reflected back into the greenhouse, during daylight hours, by the reflective component. This way the material may absorb the maximum amount of NIR, and reflect the maximum amount of PAR, thereby providing heating and PAR light into the greenhouse.

Greenlight and UV light are weakly absorbed by plants. Therefore, much of the light in these regions may penetrate the canopy and reach the ground floor. By also using a luminescent material, which down-converts the UV or green portion of the spectrum to the usable blue or red portions in the ground covering material, the amount of available PAR light that may be reflected back to the plants is enhanced.

By including phase change material and luminescent materials within the thermally absorbing ground covering, the thermal energy can be stored while the utilization of PAR light can be maximized. This allows for the storage of the thermal energy, which is absorbed by the spectrally selective pigment during the daylight hours, to be released during the night-time when temperatures drop. During the daylight hours, PAR light is reflected by the reflective pigments, but importantly, the less efficiently used parts of the PAR spectrum, such as green light, may be absorbed and re-emitted as a more useful light for the plants. By including such materials in the industrial polymer or as a coating the thermal efficiency of the covering as a whole can be enhanced, the release of the thermal energy can be offset and maximum PAR can be given to the plants.

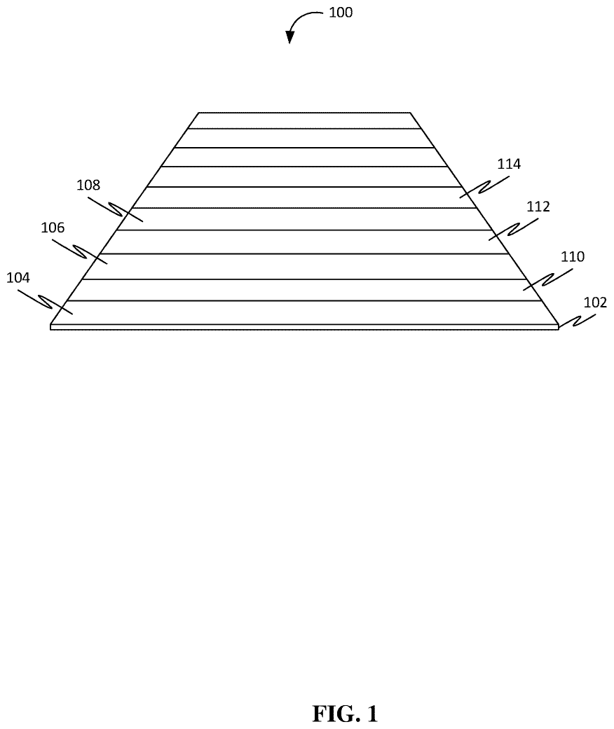

FIG. 1 is a top perspective view of a structure 100 for facilitating spectrally selective transformation of light waves, in accordance with some embodiments. Further, the structure 100 may include a panel, a sheet, a cover, a groundsheet, etc. Further, the structure 100 may be a spectrally selective cover, a spectrally selective groundsheet, etc. Further, the light waves may include sunlight, electromagnetic waves, electromagnetic radiations, scattered light, etc. Further, one or more regions of the light wave correspond to one or more regions of the spectrum of the light wave. Further, the structure 100 may be used for covering a ground, a surface, a floor, etc. Further, the structure 100 may include a substrate 102. Further, the substrate 102 may be comprised of at least one polymer (industrial polymer), a polymer sheet, a ground covering material, etc. Further, the at least one polymer may include polypropylene, polyethylene, High-Density Polyethylene (HDPE), etc. Further, the substrate 102 may include at least one first substrate portion 104-108 and at least one second substrate portion 110-114.

Further, the at least one first substrate portion 104-108 may include at least one first material. Further, the at least one first material has a first level of reflection for a first region of the light wave and one or more first levels of reflection for one or more first regions of the light wave. Further, the first level of reflection may be greater than one or more first levels of reflection. Further, the at least one first material may include highly scattering pigments such as metal oxides (titanium oxide (TiO2) or zinc oxide (ZnO)) and metal carbonates (calcium carbonate (CaCO3) and magnesium carbonate (MgCO3)) or metallic pigments such as aluminum, silver, and tungsten. Further, the at least one first material may be a reflective component. Further, the reflective component may include a reflective pigment. Further, in an embodiment, the at least one first substrate portion 104-108 may be coated with the at least one first material. Further, in an embodiment, the at least one first material may be infused in the at least one first substrate portion 104-108. Further, in an embodiment, the at least one first material may be compounded inside the at least one first substrate portion 104-108

Further, the at least one second substrate portion 110-114 may be assembled with the at least one first substrate portion 104-108. Further, the at least one second substrate portion 110-114 may include at least one second material. Further, the at least one second material has a second level of transmission for the first region of the light wave and one or more second levels of transmission for the one or more first regions of the light wave. Further, the second level of transmission may be greater than the one or more second levels of transmission. Further, the at least one second material has a third level of absorption for a second region of the light wave and one or more third levels of absorption for one or more second regions of the light wave. Further, the second level of absorption may be greater than the one or more second levels of absorption. Further, the at least one second material may be a near-infrared radiation (NIR) absorber. Further, the at least one second material may include doped metal oxide nanoparticles such as doped tungsten oxide, lanthanum hexaboride, and near-infrared (or NIR) absorbing dyes. Further, the at least one second material may be comprised of Cesium Tungsten Oxide nanoparticles. Further, the at least one second material may be a spectrally selective component. Further, in an embodiment, the at least one second substrate portion 110-114 may be coated with the at least one second material. Further, in an embodiment, the at least one second material may be infused in the at least one second substrate portion 110-114. Further, in an embodiment, the at least one second material may be compounded inside the at least one second substrate portion 110-114. Further, in an embodiment, the at least one first substrate portion 104-108 may include the at least one second substrate portion 110-114. Further, the at least one second material may be compounded with the at least one first material in the at least one second substrate portion 110-114. Further, in an embodiment, the at least one second material may be coated on the at least one second substrate portion 110-114 over the at least one first material. Further, the at least one second substrate portion 110-114 may be configured for absorbing at least one light wave portion associated with the second region of the light wave based on the at least one second material. Further, the at least one light wave portion may be near-infrared radiation. Further, the at least one second substrate portion 110-114 may be configured for producing at least one amount of thermal energy based on the absorbing of the at least one light wave portion. Further, the thermal energy produced may be transferred via conduction, convection, and radiation. Further, the thermal energy may include infrared radiation.

Further, in some embodiments, the first region and the one or more first regions form the light wave. Further, the first region of the light wave may be a Photosynthetically Active Radiation (PAR) region of the light wave.

Further, in an embodiment, the PAR region may be characterized by a wavelength of the light wave ranging from 400 nm (nanometers) to 700 nm (nanometers). Further, in an embodiment, the at least one first substrate portion 104-108 may reflect at least one a light wave portion of the light wave associated with the PAR region of the light wave based on the at least one first material. Further, in an embodiment, the at least one second substrate portion 110-114 may be transparent to the first region of the light wave based on the at least one second material having the second level of transmission for the first region of the light wave greater than the one or more second levels of transmission for the one or more first regions of the light wave. Further, the one or more first regions of the light wave may be a portion of a spectrum of the light wave excluding the first region of the light wave.

Further, in some embodiments, the second region and the one or more second regions form the light wave. Further, the second region of the light wave may be a Near-Infrared Radiation (NIR) region of the light wave.

Further, in an embodiment, the NIR region may be characterized by a wavelength of the light wave ranging from 700 nm (nanometers) to 2500 nm (nanometers).

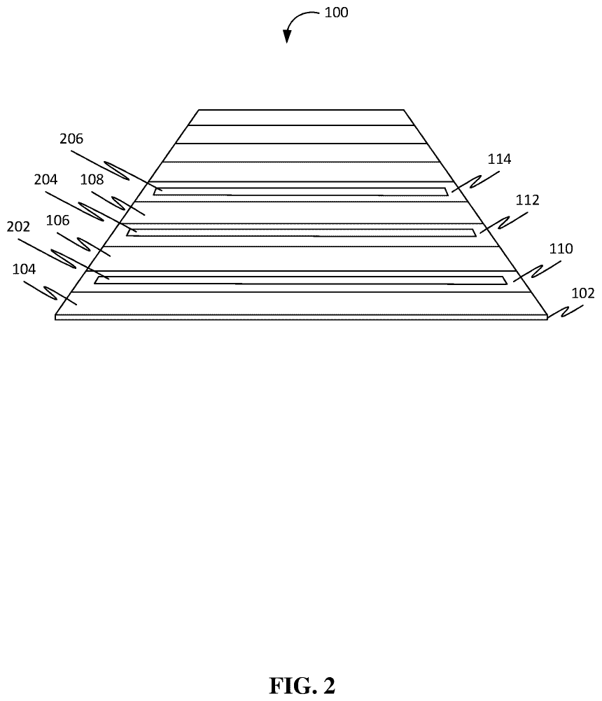

Further, in some embodiments, the substrate 102 may include at least one third substrate portion 202-206, as shown in FIG. 2, assembled with the at least one first substrate portion 104-108 and the at least one second substrate portion 110-114. Further, the at least one third portion may include at least one third material. Further, the at least one third material transitions between at least one first state and at least one second state for at least one of storing and releasing at least one portion of the at least one amount of the thermal energy. Further, the at least one third material may include phase change material (PCM). Further, in an embodiment, the at least one third material may be infused or compounded inside the at least one third substrate portion 202-206.

Further, in an embodiment, the at least one third substrate portion 202-206 may be configured for absorbing the at least one portion of the at least one amount of the thermal energy based on the producing by transitioning from the at least one first state to the at least one second state. Further, the at least one third substrate portion 202-206 may be configured for storing the at least one portion of the at least one amount of the thermal energy based on the absorbing during the producing of the at least one amount of the thermal energy. Further, the at least one third substrate portion 202-206 may be configured for releasing the at least one portion of the at least one amount of the thermal energy based on the storing after the producing of the at least one amount of the thermal energy.

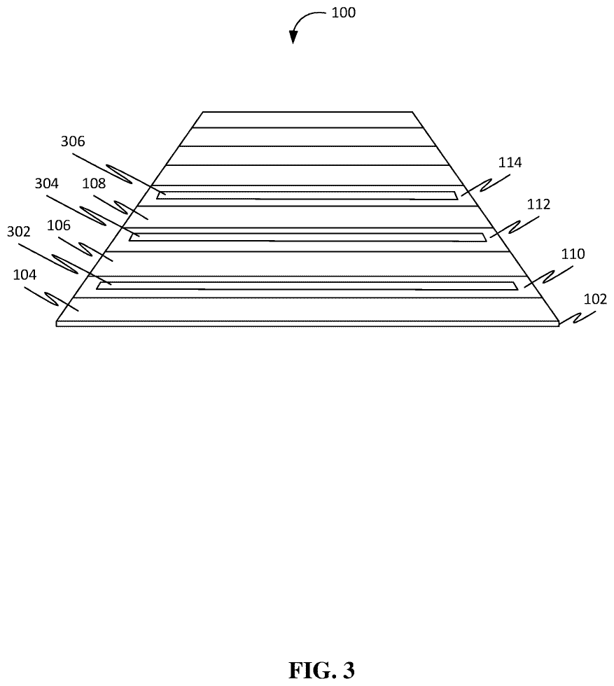

Further, in some embodiments, the substrate 102 may include at least one fourth substrate portion 302-306, as shown in FIG. 3, assembled with the at least one first substrate portion 104-108 and the at least one second substrate portion 110-114. Further, the at least one fourth substrate portion 302-306 may include at least one fourth material. Further, the at least one fourth material transforms at least one second light wave portion of the light wave from at least one third region of the light wave to at least one fourth region of the light wave. Further, the at least one fourth material may include luminescent material. Further, in an embodiment, the at least one fourth material may be infused or compounded inside the at least one fourth substrate portion 302-306. Further, in an embodiment, the at least one fourth substrate portion 302-306 may be coated with the at least one fourth material. Further, the at least one third region of the light wave may include a green region, an ultraviolet region, etc., of an electromagnetic spectrum. Further, the at least one fourth region may include a blue region, a red region, etc., of the electromagnetic spectrum.

Further, in an embodiment, the at least one fourth substrate portion 302-306 may be configured for absorbing the at least one second light wave portion of the light wave associated with the at least one third region of the light wave. Further, the at least one fourth substrate portion 302-306 may be configured for producing the at least one second light wave portion of the light wave associated with the at least one fourth region of the light wave based on the absorbing of the at least one second light wave portion by transforming the at least one second light wave portion of the light wave from the at least one third region to the at least one fourth region.

Further, in some embodiments, the at least one second material may include at least one of at least one doped metal oxide nanoparticle and at least one near-infrared radiation (NIR) absorbing dye.

Further, in some embodiments, the at least one first substrate portion 104-108 and the at least one second substrate portion 110-114 may be associated with a thickness. Further, the thickness may be 50 micrometers.

Further, in some embodiments, at least one second substrate portion 110-114 may include the at least one second material in an amount of 0.6% by weight based on the total weight of at least one second substrate portion 110-114.

FIG. 2 is a top perspective view of the structure 100, in accordance with some embodiments.

FIG. 3 is a top perspective view of the structure 100, in accordance with some embodiments.

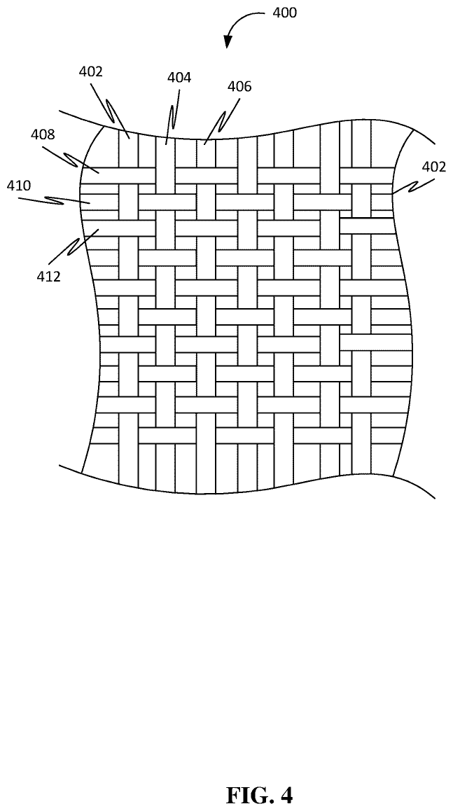

FIG. 4 is an enlarged partial view of a structure 400 for facilitating spectrally selective transformation of light waves, in accordance with some embodiments. Further, the structure may be a sheet. Further, the structure 400 may be comprised of a plurality of tapes 402-412. Further, the plurality of tapes 402-412 may be woven for forming the structure 400. Further, the plurality of tapes 402-412 may be divided into a plurality of warp tapes 402-406 and a plurality of weft tapes 408-412. Further, the plurality of warp tapes 402-406 may be comprised of a polymer (such as High-Density Polyethylene (HDPE)) comprising Cesium Tungsten Oxide nanoparticles (such as the at least one second material). Further, the plurality of weft tapes 408-412 may be comprised of a polymer (such as High-Density Polyethylene (HDPE)) comprising a reflective pigment (such as the at least one first material).

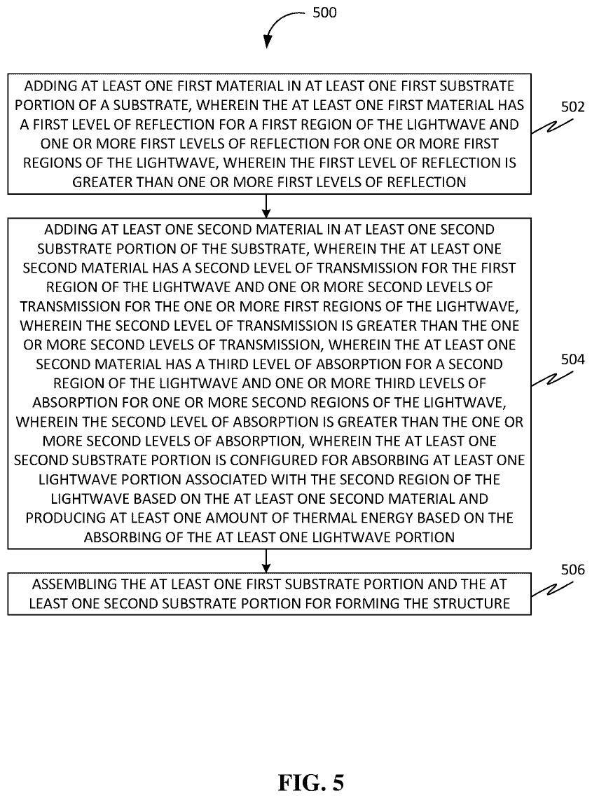

FIG. 5 is a flowchart of a method 500 for producing a structure for facilitating spectrally selective transformation of light waves, in accordance with some embodiments.

Further, at 502, the method 500 may include adding at least one first material in at least one first substrate portion of a substrate. Further, the at least one first material has a first level of reflection for a first region of the light wave and one or more first levels of reflection for one or more first regions of the light wave. Further, the first level of reflection may be greater than one or more first levels of reflection. Further, the adding of the at least one first material may include coating the at least one first material on the at least one first substrate portion. Further, the adding of the at least one first material may include compounding the at least one first material inside the at least one first substrate portion.

Further, at 504, the method 500 may include adding at least one second material in at least one second substrate portion of the substrate. Further, the at least one second material has a second level of transmission for the first region of the light wave and one or more second levels of transmission for the one or more first regions of the light wave. Further, the second level of transmission may be greater than the one or more second levels of transmission. Further, the at least one second material has a third level of absorption for a second region of the light wave and one or more third levels of absorption for one or more second regions of the light wave. Further, the second level of absorption may be greater than the one or more second levels of absorption. Further, the at least one second substrate portion may be configured for absorbing at least one light wave portion associated with the second region of the light wave based on the at least one second material. Further, the at least one second substrate portion may be configured for producing at least one amount of thermal energy based on the absorbing of the at least one light wave portion. Further, the adding of the at least one second material may include coating the at least one second material on the at least one second substrate portion. Further, the adding of the at least one second material may include compounding the at least one second material inside the at least one second substrate portion.

Further, at 506, the method 500 may include assembling the at least one first substrate portion and the at least one second substrate portion for forming the structure. Further, the assembling may include integrating the at least one first substrate portion and the at least one second substrate portion. Further, the assembling may include extruding the at least one first substrate portion into a plurality of weft tapes and the at least one second substrate portion into a plurality of warp tapes. Further, the assembling may include weaving the plurality of warp tapes and the plurality of weft tapes in the structure.

Further, in some embodiments, the first region and the one or more first regions form the light wave. Further, the first region of the light wave may be a Photosynthetically Active Radiation (PAR) region of the light wave.

Further, in an embodiment, the PAR region may be characterized by a wavelength of the light wave ranging from 400 nm to 700 nm.

Further, in some embodiments, the second region and the one or more second regions form the light wave. Further, the second region of the light wave may be a Near-Infrared Radiation (NIR) region of the light wave.

Further, in an embodiment, the NIR region may be characterized by a wavelength of the light wave ranging from 700 nm to 2500 nm.

Further, in some embodiments, the at least one second material may include at least one of at least one doped metal oxide nanoparticle and at least one near-infrared radiation (NIR) absorbing dye.

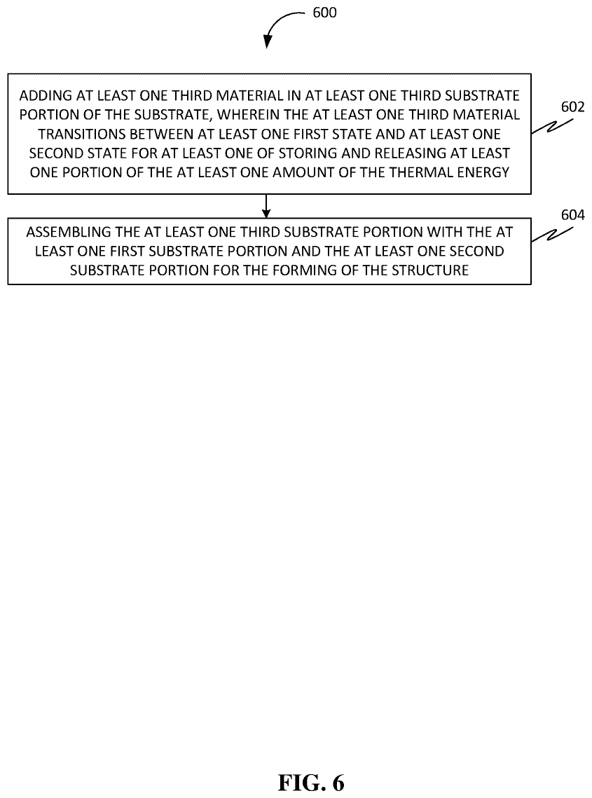

FIG. 6 is a flowchart of a method 600 for producing the structure for facilitating spectrally selective transformation of light waves, in accordance with some embodiments.

Further, at 602, the method 600 may include adding at least one third material in at least one third substrate portion of the substrate. Further, the at least one third material transitions between at least one first state and at least one second state for at least one of storing and releasing at least one portion of the at least one amount of the thermal energy. and

Further, at 604, the method 600 may include assembling the at least one third substrate portion with the at least one first substrate portion and the at least one second substrate portion for the forming of the structure.

Further, in some embodiments, the at least one third substrate portion may be configured for absorbing the at least one portion of the at least one amount of the thermal energy based on the producing by transitioning from the at least one first state to the at least one second state. Further, the at least one third substrate portion may be configured for storing the at least one portion of the at least one amount of the thermal energy based on the absorbing during the producing of the at least one amount of the thermal energy. Further, the at least one third substrate portion may be configured for releasing the at least one portion of the at least one amount of the thermal energy based on the storing after the producing of the at least one amount of the thermal energy.

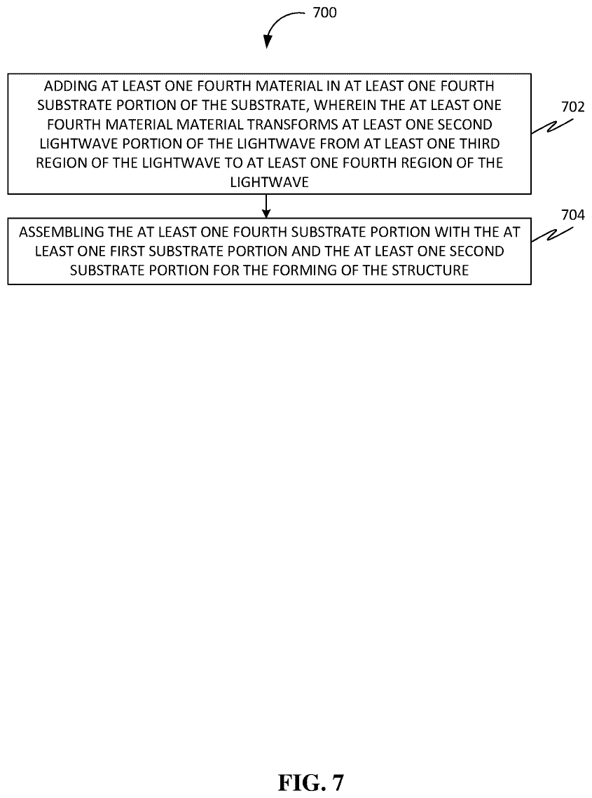

FIG. 7 is a flowchart of a method 700 for producing the structure for facilitating spectrally selective transformation of light waves, in accordance with some embodiments.

Further, at 702, the method 700 may include adding at least one fourth material in at least one fourth substrate portion of the substrate. Further, the at least one fourth material transforms at least one second light wave portion of the light wave from at least one third region of the light wave to at least one fourth region of the light wave.

Further, at 704, the method 700 may include assembling the at least one fourth substrate portion with the at least one first substrate portion and the at least one second substrate portion for the forming of the structure.

Further, in some embodiments, the at least one fourth substrate portion may be configured for absorbing the at least one second light wave portion of the light wave associated with the at least one third region of the light wave. Further, the at least one fourth substrate portion may be configured for producing the at least one second light wave portion of the light wave associated with the at least one fourth region of the light wave based on the absorbing of the at least one second light wave portion by transforming the at least one second light wave portion of the light wave from the at least one third region to the at least one fourth region.

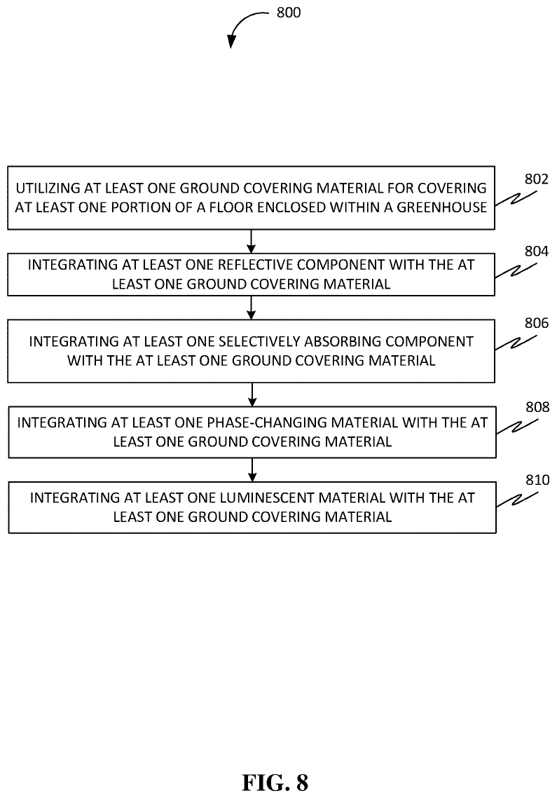

FIG. 8 is a flowchart of a method 800 for producing spectrally selective horticulture ground covering, in accordance with some embodiments.

Further, at 802, the method 800 may include a step of utilizing at least one ground-covering material for covering at least one portion of a floor enclosed within a greenhouse. Further, the at least one ground-covering material may include an industrial polymer such as but not limited to polypropylene and polyethylene.

Further, at 804, the method 800 may include a step of integrating at least one reflective component with the at least one ground-covering material. Further, the at least one reflective component may include highly scattering pigments such as metal oxides, for example, TiO₂ and ZnO. Further, the at least one reflective component may include metal carbonates such as CaCO₃ and MgCO₃. Furthermore, the at least one reflective component may include metallic pigments such as aluminum, silver, and tungsten.

Further, at 806, the method 800 may include a step of integrating at least one selectively absorbing component with the at least one ground-covering material. Further, the at least one selectively absorbing component may include an absorbing pigment with high transparency in the visible/PAR region with a wavelength range of 400-700 nanometers and high absorption in the NIR region of the spectrum with a wavelength range of 700-2500 nanometers. Further, the at least one selectively absorbing component may include doped metal oxide nanoparticles such as doped tungsten oxide, lanthanum hexaboride, and NIR-absorbing dyes. Further, the at least one selectively absorbing component may be compounded inside the at least one ground-covering material along with the at least one reflective component. Further, the at least one selectively absorbing component may be coated as a layer on the at least one ground-covering material and the at least one reflective component.

Further, at 808, the method 800 may include a step of integrating at least one phase-changing material with the at least one ground-covering material. Further, the at least one phase-changing material may include a material that undergoes a phase change within the temperature range of −20 Celsius to 100 Celsius. Further, the at least one phase-changing material may include paraffin waxes, hydrated salts, and bio-derived materials such as oleic acid.

Further, at 810, the method 800 may include a step of integrating at least one luminescent material with the at least one ground-covering material. Further, the at least one luminescent material may absorb light with a wavelength falling within a range of 200-750 nanometers. Further, the at least one luminescent material may re-emit light with a wavelength falling within a range of 250-750 nanometers. Further, the at least one luminescent material may include perylene dyes, quantum dots, and rhodamine dyes. Further, the at least one luminescent material may enhance usable PAR light.

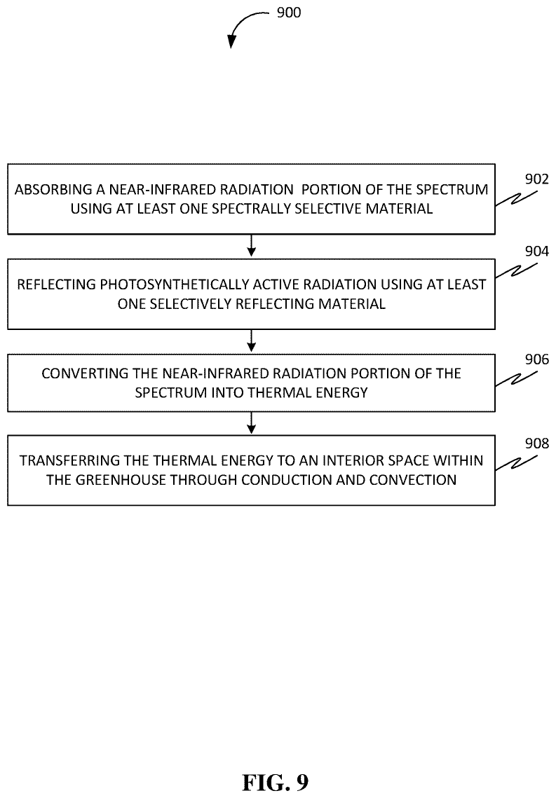

FIG. 9 is a flowchart of a method 900 for facilitating enhancing photosynthetically active radiation and heating in a greenhouse, in accordance with some embodiments.

Further, at 902, the method 900 may include a step of absorbing a near-infrared radiation (or NIR) portion of the spectrum using at least one spectrally selective material. Further, the at least one spectrally selective material may include doped metal oxide nanoparticles such as doped tungsten oxide, lanthanum hexaboride, and NIR-absorbing dyes.

Further, at 904, the method 900 may include a step of reflecting photosynthetically active radiation (or PAR) using at least one selectively reflecting material. Further, the at least one selectively reflecting material may include highly scattering pigments such as metal oxides, for example, TiO₂ and ZnO. Further, the at least one selectively reflecting material may include metal carbonates such as CaCO₃ and MgCO₃. Furthermore, the at least one selectively reflecting material may include metallic pigments such as aluminum, silver, and tungsten.

Further, at 906, the method 900 may include a step of converting the near-infrared radiation (or NIR) portion of the spectrum into thermal energy.

Further, at 908, the method 900 may include a step of transferring the thermal energy to an interior space within the greenhouse through conduction and convection.

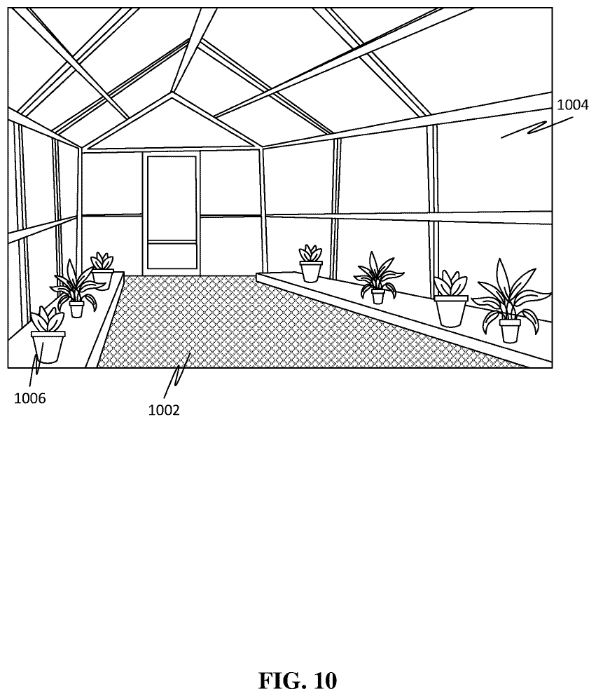

FIG. 10 illustrates a structure 1002 disposed on a horticulture ground enclosed by a greenhouse 1004, in accordance with some embodiments. Further, the structure 1002 may be a spectrally selective cover, a spectrally selective groundsheet, etc. Further, the greenhouse 1004 may be used for growing at least one plant 1006.

Further, the spectrally selective cover may include a polymer sheet. Further, the polymer sheet may include polypropylene and polyethylene. Further, the spectrally selective cover may include a reflective component integrated with the polymer sheet. Further, the reflective component may include highly scattering pigments such as metal oxides, for example, TiO₂ and ZnO. Further, the reflective component may include metal carbonates such as CaCO₃ and MgCO₃. Furthermore, the reflective component may include metallic pigments such as aluminum, silver, and tungsten. Further, the reflective component may be configured to selectively reflect photosynthetically active radiation (or PAR).

Further, the spectrally selective cover may include a selectively absorbing component integrated into the polymer sheet. Further, the selectively absorbing component may include an absorbing pigment with high transparency in the visible/PAR region with a wavelength range of 400-700 nanometers and high absorption in the NIR region of the spectrum with a wavelength range of 700-2500 nanometers. Further, the selectively absorbing component may include doped metal oxide nanoparticles such as doped tungsten oxide, lanthanum hexaboride, and NIR-absorbing dyes. Further, the selectively absorbing component may be coated as a layer on top of the polymer sheet. Further, the near-infrared radiation may be converted into thermal energy. Further, the thermal energy may be transferred to an interior space within the greenhouse 1004 through conduction and convection to create a favorable environment inside the greenhouse 1004 to facilitate growing the at least one plant 1006 healthily.

Further, the spectrally selective cover may include a phase-changing component integrated with the polymer sheet. Further, the phase-changing component may include a material that undergoes a phase change within the temperature range of −20 Celsius to 100 Celsius. Further, the phase-changing component may include paraffin waxes, hydrated salts, and bio-derived materials such as oleic acid. Further, the phase-changing component may facilitate storing excess thermal energy in the polymer sheet.

Further, the spectrally selective cover may include a luminescent material integrated with the polymer sheet. Further, the luminescent material may absorb light with a wavelength falling within a range of 200-750 nanometers. Further, the luminescent material may re-emit light with a wavelength falling within a range of 250-750 nanometers. Further, the luminescent material may include perylene dyes, quantum dots, and rhodamine dyes.

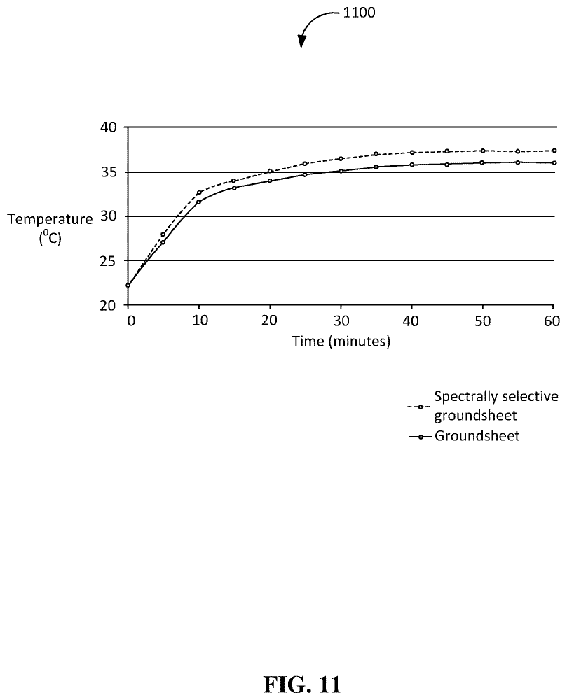

FIG. 11 illustrates a graph 1100 showing temperature curves of a spectrally selective groundsheet and a groundsheet disposed in a greenhouse, in accordance with some embodiments. Further, the graph 1100 plots the temperature curves by measuring temperatures of the spectrally selective groundsheet and the groundsheet in relation to time (minutes).

Further, the temperature curves are recorded in the greenhouse which may be fabricated from Perspex sheets and exposed to the midday sunlight. Further, the groundsheet may be a standard groundsheet which may be woven by warp tapes and weft tapes. Further, the warp tapes and weft tapes of the groundsheet may be comprised of high-density polyethylene and include white (reflective) pigment. Further, the spectrally selective groundsheet may be woven by warp tapes and weft tapes. Further, the warp tapes of the spectrally selective groundsheet include 0.6% Cesium Tungsten Oxide nanoparticles (NIR absorber). Further, the weft tapes of the spectrally selective groundsheet may include Cesium Tungsten Oxide nanoparticles. Further, the temperature curves of the graph 1100 shows that the spectrally selective groundsheet increases the temperature of the greenhouse by 1.5 degree Celsius relative to the standard groundsheet.

Although the present disclosure has been explained in relation to its preferred embodiment, it is to be understood that many other possible modifications and variations can be made without departing from the spirit and scope of the disclosure.

What is claimed is:

1. A structure for facilitating spectrally selective transformation of light waves, the structure comprising a substrate comprising:
at least one first substrate portion comprising at least one first material, wherein the at least one first material has a first level of reflection for a first region of the light wave and one or more first levels of reflection for one or more first regions of the light wave, wherein the first level of reflection is greater than one or more first levels of reflection; and
at least one second substrate portion assembled with the at least one first substrate portion, wherein the at least one second substrate portion comprises at least one second material, wherein the at least one second material has a second level of transmission for the first region of the light wave and one or more second levels of transmission for the one or more first regions of the light wave, wherein the second level of transmission is greater than the one or more second levels of transmission, wherein the at least one second material has a third level of absorption for a second region of the light wave and one or more third levels of absorption for one or more second regions of the light wave, wherein the second level of absorption is greater than the one or more second levels of absorption, wherein the at least one second substrate portion is configured for:
absorbing at least one light wave portion associated with the second region of the light wave based on the at least one second material; and
producing at least one amount of thermal energy based on the absorbing of the at least one light wave portion.

2. The structure of claim 1, wherein the first region and the one or more first regions form the light wave, wherein the first region of the light wave is a Photosynthetically Active Radiation (PAR) region of the light wave.

3. The structure of claim 2, wherein the PAR region is characterized by a wavelength of the light wave ranging from 400 nm to 700 nm.

4. The structure of claim 1, wherein the second region and the one or more second regions form the light wave, wherein the second region of the light wave is a Near-Infrared Radiation (NIR) region of the light wave.

5. The structure of claim 4, wherein the NIR region is characterized by a wavelength of the light wave ranging from 700 nm to 2500 nm.

6. The structure of claim 1, wherein the substrate comprises at least one third substrate portion assembled with the at least one first substrate portion and the at least one second substrate portion, wherein the at least one third portion comprises at least one third material, wherein the at least one third material transitions between at least one first state and at least one second state for at least one of storing and releasing at least one portion of the at least one amount of the thermal energy.

7. The structure of claim 6, wherein the at least one third substrate portion is configured for:
absorbing the at least one portion of the at least one amount of the thermal energy based on the producing by transitioning from the at least one first state to the at least one second state;
storing the at least one portion of the at least one amount of the thermal energy based on the absorbing during the producing of the at least one amount of the thermal energy; and
releasing the at least one portion of the at least one amount of the thermal energy based on the storing after the producing of the at least one amount of the thermal energy.

8. The structure of claim 1, wherein the substrate comprises at least one fourth substrate portion assembled with the at least one first substrate portion and the at least one second substrate portion, wherein the at least one fourth substrate portion comprises at least one fourth material, wherein the at least one fourth material transforms at least one second light wave portion of the light wave from at least one third region of the light wave to at least one fourth region of the light wave.

9. The structure of claim 8, wherein the at least one fourth substrate portion is configured for:
absorbing the at least one second light wave portion of the light wave associated with the at least one third region of the light wave; and
producing the at least one second light wave portion of the light wave associated with the at least one fourth region of the light wave based on the absorbing of the at least one second light wave portion by transforming the at least one second light wave portion of the light wave from the at least one third region to the at least one fourth region.

10. The structure of claim 1, wherein the at least one second material comprises at least one of at least one doped metal oxide nanoparticle and at least one near-infrared radiation (NIR) absorbing dye.

11. A method for producing a structure for facilitating spectrally selective transformation of light waves, the method comprising:
adding at least one first material in at least one first substrate portion of a substrate, wherein the at least one first material has a first level of reflection for a first region of the light wave and one or more first levels of reflection for one or more first regions of the light wave, wherein the first level of reflection is greater than one or more first levels of reflection;
adding at least one second material in at least one second substrate portion of the substrate, wherein the at least one second material has a second level of transmission for the first region of the light wave and one or more second levels of transmission for the one or more first regions of the light wave, wherein the second level of transmission is greater than the one or more second levels of transmission, wherein the at least one second material has a third level of absorption for a second region of the light wave and one or more third levels of absorption for one or more second regions of the light wave, wherein the second level of absorption is greater than the one or more second levels of absorption, wherein the at least one second substrate portion is configured for:
absorbing at least one light wave portion associated with the second region of the light wave based on the at least one second material; and
producing at least one amount of thermal energy based on the absorbing of the at least one light wave portion; and
assembling the at least one first substrate portion and the at least one second substrate portion for forming the structure.

12. The method of claim 11, wherein the first region and the one or more first regions form the light wave, wherein the first region of the light wave is a Photosynthetically Active Radiation (PAR) region of the light wave.

13. The method of claim 12, wherein the PAR region is characterized by a wavelength of the light wave ranging from 400 nm to 700 nm.

14. The method of claim 11, wherein the second region and the one or more second regions form the light wave, wherein the second region of the light wave is a Near-Infrared Radiation (NIR) region of the light wave.

15. The method of claim 14, wherein the NIR region is characterized by a wavelength of the light wave ranging from 700 nm to 2500 nm.

16. The method of claim 11 further comprising:
adding at least one third material in at least one third substrate portion of the substrate, wherein the at least one third material transitions between at least one first state and at least one second state for at least one of storing and releasing at least one portion of the at least one amount of the thermal energy; and
assembling the at least one third substrate portion with the at least one first substrate portion and the at least one second substrate portion for the forming of the structure.

17. The method of claim 16, wherein the at least one third substrate portion is configured for:
absorbing the at least one portion of the at least one amount of the thermal energy based on the producing by transitioning from the at least one first state to the at least one second state;
storing the at least one portion of the at least one amount of the thermal energy based on the absorbing during the producing of the at least one amount of the thermal energy; and
releasing the at least one portion of the at least one amount of the thermal energy based on the storing after the producing of the at least one amount of the thermal energy.

18. The method of claim 11 further comprising:
adding at least one fourth material in at least one fourth substrate portion of the substrate, wherein the at least one fourth material transforms at least one second light wave portion of the light wave from at least one third region of the light wave to at least one fourth region of the light wave; and
assembling the at least one fourth substrate portion with the at least one first substrate portion and the at least one second substrate portion for the forming of the structure.

19. The method of claim 18, wherein the at least one fourth substrate portion is configured for:
absorbing the at least one second light wave portion of the light wave associated with the at least one third region of the light wave; and
producing the at least one second light wave portion of the light wave associated with the at least one fourth region of the light wave based on the absorbing of the at least one second light wave portion by transforming the at least one second light wave portion of the light wave from the at least one third region to the at least one fourth region.

20. The method of claim 11, wherein the at least one second material comprises at least one of at least one doped metal oxide nanoparticle and at least one near-infrared radiation (NIR) absorbing dye.
